(19) United States
(12) Patent Application Publication
(10) Pub. No.: US 2014/0301375 A1
(43) Pub. Date: Oct. 9, 2014

(54) TIMING ADVANCE METHOD FOR SYNCHRONIZED WIFI NETWORK

(71) Applicants: Ashraf Nusairat, Hoffman Estates, IL (US); Mohammad Isam Malkawi, Chicago, IL (US); Basman Dahleh, Palos Heights, IL (US)

(72) Inventors: Ashraf Nusairat, Hoffman Estates, IL (US); Mohammad Isam Malkawi, Chicago, IL (US); Basman Dahleh, Palos Heights, IL (US)

(21) Appl. No.: 13/857,850

(22) Filed: Apr. 5, 2013

(51) Int. Cl. H04W 56/00; H04L 5/00

(52) U.S. Cl. CPC H04W 56/0045; H04L 5/0058
USPC 370/336

(57) ABSTRACT

A wireless communication system timing introduces a timing advance calculation mechanism. The timing advance calculation mechanism allows a communication device in the system to adjust its transmission timing to ensure reliable receipt of its transmissions at a receiver. The timing advance calculation mechanism is based on exchanging two new media access control layer messages between the transmitter and the receiver. The procedure is triggered by the transmitter planning to associate with a network managed by the receiver.

### BACKGROUND

The present application relates generally to communication networks. More particularly, the present application relates to a timing advance method for a synchronized WiFi network.

Wireless broadband networks have become very popular for data communication. Such networks may be set up relatively inexpensively and quickly. Such networks may provide local communication among network client devices through an access point which controls communication in the network. Instead, or in addition, such networks may provide communication access to remote networks including the Internet.

The Institute of Electrical and Electronics Engineers has promulgated several data communication standards which have subsequently been adopted by industry. One example of a family of such standards is commonly referred to IEEE 802.11. IEEE 802.11 includes several protocols including IEEE 802.11a, IEEE 802.11b, IEEE 802.11g and IEEE 802.11n. 802.11 networks and devices are commonly referred to as WiFi devices. According to the protocol, an access point or base station controls data communication including timing synchronization in a service area around the access point. Client devices operate according to the same protocol to communicate with the access point. Messaging is defined by the protocol.

To improve the utility of these networks, manufacturers have been expanding the range of communication and thus the size of the service area. Initially, WiFi communication was limited to line of sight or a few tens of meters. More recently, networks are being developed with a service area radius or node size of 5 to 15 km.

Increasing the scale of networks in this manner has met with commercial success. This success has created a need for additional features in systems and methods for communication.

### BRIEF SUMMARY

A wireless communication system timing introduces a timing advance calculation mechanism. The timing advance calculation mechanism allows a communication device in the system to adjust its transmission timing to ensure reliable receipt of its transmissions at a receiver. The timing advance calculation mechanism is based on exchanging two new media access control layer messages between the transmitter and the receiver. The procedure is triggered by the transmitter planning to associate with a network managed by the receiver.

### BRIEF DESCRIPTION OF THE DRAWINGS

FIG. 1 is a block diagram of a communication system;

FIG. 2 is a block diagram of a representative access point and representative client device;

FIG. 3 is a timing diagram illustrating operation of the communication system of FIG. 1;

FIG. 4 is a timing diagram illustrating operation of the communication system of FIG. 1;

FIG. 5 is a flow diagram illustrating communication between an access point and a client device in a communication system; and

FIG. 6 is a flow diagram illustrating a method for determining timing advance in a communication network.

### DETAILED DESCRIPTION OF THE DRAWINGS AND THE PRESENTLY PREFERRED EMBODIMENTS

In accordance with the embodiments disclosed herein, a communication system provides apparatus and method for ensuring reliable communication, even when wireless clients are at varying distances from an access point in a wireless service area. When distances vary and are larger than a few tens of meters, propagation delay from the remote client device to the access point can be significant. The propagation delay can cause a collision of more than one transmission from client devices at the receiver of the access point. Because of the collision, no client device transmission will be received and the efficiency and reliability of the system are reduced.

A new message is introduced by which a wireless client device can request data for a timing advance calculation. The message is transmitted to the access point with a timestamp of its transmission time. The access point records the time of reception of the message and responds to the message by transmitting a response message to the requesting client device. The response message includes timing data sufficient for the client device to determine the propagation delay from the client device to the access point. The client device may then use the propagation delay to advance timing of its subsequent transmissions to the access point so that the messages are received reliably at the correct time at the receiver of the access point. In one exemplary embodiment, the system may from time to time update the calculation of the propagation delay in order to accommodate changes in the network, for example, due to device mobility.

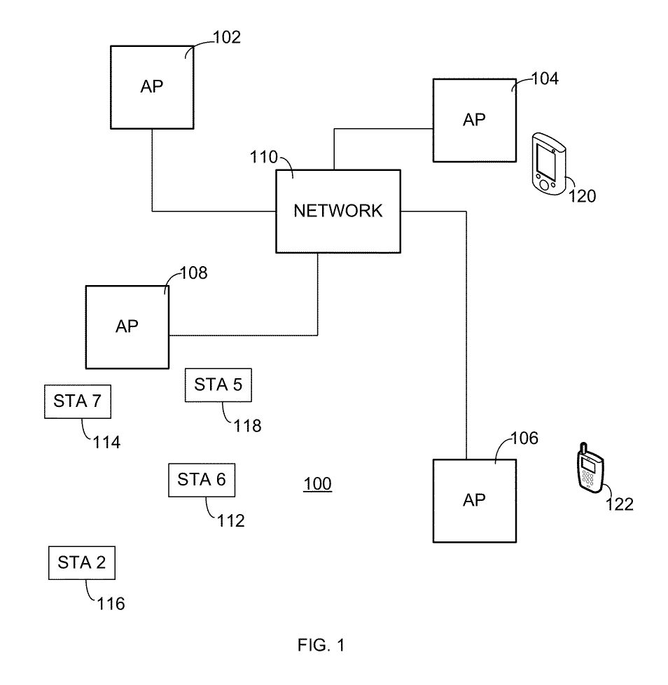

Referring now to the drawing, FIG. 1 is a block diagram of a communication system 100. The communication system 100 is intended to be exemplary only for purposes of illustrating the concepts described herein.

In this exemplary embodiment, the communication system includes a first access point 102, a second access point 104, a third access point 106 and a fourth access point 108. Each respective access point provides radio communication to a service area surrounding the respective access point. In the illustrated embodiment, each respective access point 102, 104, 106, 108 operates according to the Institute of Electrical and Electronic Engineers (IEEE) standard 802.11n, commonly referred to as WiFi. In other embodiments, one or more of the access points 102, 104, 106, 108 operates according to another wireless standard such as WiMAX or another of the family of 802.11 standards. The devices and techniques described herein may be extended to standards and protocols other than IEEE 802.11n.

In the example of FIG. 1, each respective access point operates as a base station for radio devices within a cell or service area surrounding the access point. In this example, the access point 108 provides radio communication service to one or more station near the access point. Each station (STA) communicates with the access point using a radio communication protocol such as IEEE 802.11n. The radio communication protocol defines frequency allocation, timing, frame structure and other characteristics of the transmission and reception of information between radio devices including the access point and the radio devices.

In the example of FIG. 1, the access point 108 is in radio communication with three radio devices, including a first station 112, a second station 114, a third station 116 and a fourth station 118. In this example, the first station 112 is designated STA 6, the second station 114 is designated STA 7, the third station 116 is designated STA 2 and the fourth station 118 is designated STA 5. The a first station 112, second station 114, third station 116 and fourth station 118 may be considered clients of the access point 108 and may be referred to as wireless client devices.

Each of first station 112, second station 114, third station 116 and fourth station 118 may include a radio communication circuit in combination with any other suitable device or equipment. Exemplary devices that may include a radio circuit and form a station or wireless client device include a mobile phone, a smart phone, a personal digital assistant (PDA), a laptop computer, a tablet computer, a personal computer and any other data processing device. A radio circuit provides data communication between the data processing device and the access point 108.

The access point 108 may, in turn, provide data communication between respective stations among the first station 112, second station 114, third station 116 and fourth station 118, or between a respective station and another network 110. The network 110 may be any network or combination of networks and may include directly or indirectly the Internet or networks in communication with the Internet. In the example of FIG. 1, each of the access points 102, 104, 106, 108 is in communication with the network 110. However, each of the access points 102, 104, 106, 108 may operate independently with no interaction with adjacent networks and no overall control or supervision of individual access points. In this example, second access point 104 is in data communication with a STA 120, embodied as a PDA, and the third access point 106 is in data communication with a STA 122, embodied as a mobile phone.

As is suggested by the arrangement of stations 112, 114, 116, 118 in FIG. 1, each station 112, 114, 116, 118 may be at a different distance from the access point 108. The relevant distance may be measured as a crowflight distance between the access point 108 and a respective station. Or, the distance may be measured by the length of one or more rays reflected from adjacent structures as radio energy travels between the station and the access point. Each station is a distance from the access point and the distance may vary over time if the station is mobile, such as a mobile phone or laptop computer.

The distance between a station and the access point will result in a propagation delay. The propagation delay may be measured as the difference between the time radio frequency (RF) energy is transmitted by one of the station and the access point and the time the RF energy is received and sensed by the other of the station and the access point. If the distance is on the order of tens of meters, the propagation delay may not be significant to timing of communication between radio circuits. On the other hand, if the distance is greater than 1 km, for example, the propagation delay may adversely affect communication in the network, as will be described in greater detail below.

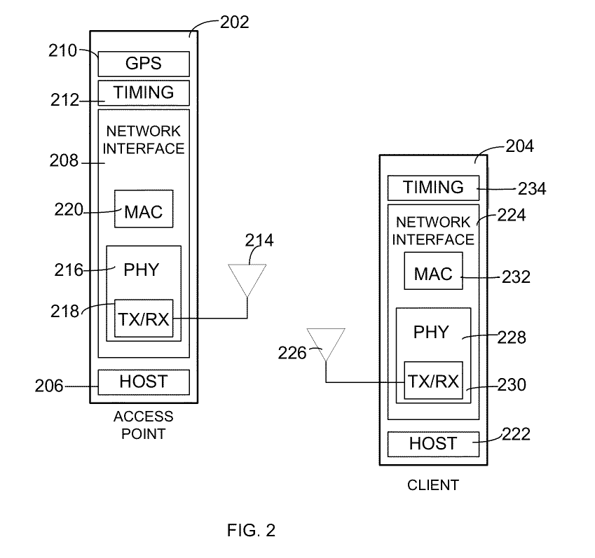

FIG. 2 is a block diagram of a representative access point 202 and representative client device 204. The access point 202 may be representative of one of the access points 102, 104, 106, 108. The client device 204 may be representative of one of the stations 112, 114, 116, 118 in FIG. 1. However, the embodiments shown are intended to be exemplary only.

The access point 202 includes a host processor 206, a network interface 208, a global positioning system (GPS) circuit 210, a timing circuit 212 and an antenna 214. In other embodiments, the access point 202 may include more or fewer or alternative elements relative to those shown in FIG. 2.

The host processor 206 controls operation of the access point 202. The host processor may include one or more circuits, modules, interfaces or code for implementing control functions. For example, the host processor 206 may include a microprocessor and memory. The memory may store data and instructions for controlling the microprocessor. The microprocessor in turn may operate in response to the stored data and instructions to control operation of the access point.

The network interface 208 controls data communication between the access point 202 and other devices, including the client device 204. The network interface 208 controls wireless communication using the antenna 214. In this regard, the network interface 208 may implement one or more radio circuits to transmit and receive radio communications by means of the antenna 214. The network interface 208 implements a physical layer (PHY) 216 in accordance with the OSI model of computer networking and a transmitter and receiver circuit (TX/RX) 218. Further, the network interface 208 implements a media access control layer (MAC) 220 in accordance with the OSI model.

In one embodiment, the network interface 208 implements the IEEE 802.11n protocol, including the 802.11n PHY and MAC layers. The network interface 208 may also or instead implement other data communication protocols for both wireless and wire line communication. For example, the network interface 208 may control communication to other wire line network elements such as network 110 of FIG. 1. In this regard, the network interface may implement protocols such as Ethernet or internet protocol (IP) for communication with other network elements.

The network interface 208 may include data processing circuits such as one or more processors, circuits, interfaces, modules and memory for implementing network control and communication. Moreover, the network interface 208 may include analog circuitry such as amplifiers, oscillators and filters for data communication with the antenna 214.

The antenna 214 may be any suitable device or combination of devices for transmission and reception of signals. In one example, the antenna 214 is a multiple-input, multiple-output (MIMO) antenna array for data communication. In one particular embodiment, the antenna 214 is configured for communication according to the IEEE 802.11 protocol at frequencies such as 2.4 GHz and 3.7 GHz and 5 GHz. Also, the antenna 214 may include multiple structures for communication of other signals such as GSM signals.

The GPS circuit 210 receives GPS signals or other location determination signals such as GLONASS signals. In response to the received location determination signals, the GPS circuit 210 determines geographic location of the access point 202. Also, in response to the received location determination signals, the GPS circuit 210 determines the current time with high precision. The GPS circuit 210 may communicate data about the geographic location of the access point and about the current time to other components of the access point 202, such as the timing circuit 212.

The timing circuit 212 controls timing of the access point 202. The timing circuit may receive current time data and other timing information from the GPS circuit 210. In turn, the timing circuit 212 conveys timing information to other components of the access point 202. The timing information may include data defining the current time, clocking signals, alarm signals and other information. The access point 202 may include suitable means for data communication among its components such as data and control buses by which information such as timing information may be communicated.

The client device 204 includes a host processor 222, a network interface 224, an antenna 226 and a timing circuit 234. In other embodiments, the client device may include other components providing other functionality. For example, in embodiments where the client device 204 is a mobile phone, the client device 204 includes a call processor circuit, a user interface and possibly other components such as a camera and accelerometers. In embodiments where the client device 204 is a portable computer, the client device 204 may include a keyboard, a display and a hard disk drive or other mass storage. In some embodiments, the client device 204 may be a module within a host device such as the portable computer or mobile phone.

The host processor 222 controls operation of the client device 204. The host processor 222 may include one or more circuits, modules, interfaces or code for implementing control functions. For example, the host processor 222 may include a microprocessor and memory. The memory may store data and instructions for controlling the microprocessor. The microprocessor in turn may operate in response to the stored data and instructions to control operation of the client device 204.

The network interface 224 controls data communication between the client device 204 and other devices, including the access point 202. The network interface 224 controls wireless communication using the antenna 226. In this regard, the network interface 224 may implement one or more radio circuits to transmit and receive radio communications by means of the antenna 226. In the illustrated embodiment, the network interface 224 implements a physical layer (PHY) 228 as well as a transmitter and receiver circuit (TX/RX) 230. Further, the network interface 224 implements a media access control layer (MAC) 232 in accordance with the OSI model. The network interface 224 forms a radio circuit for radio communication with a remote access point or other radio device.

In one embodiment, the network interface 224 implements the IEEE 802.11n protocol, including the 802.11n PHY layer 228 and MAC layer 232. In this regard, the client device 204 forms or is a part of an 802.11 station or STA. The network interface 224 may also or instead implement other data communication protocols for both wireless and wire line communication. For example, the network interface 224 may control communication to other components of the client device 204.

The network interface 224 may include data processing circuits such as one or more processors, circuits, interfaces, modules and memory for implementing network control and communication. Moreover, the network interface 224 may include analog circuitry such as amplifiers, oscillators and filters for communication with the antenna 226.

The antenna 226 may be any suitable device or combination of devices for transmission and reception of signals. In one example, the antenna 226 is a multiple-input, multiple-output (MIMO) antenna array for data communication. In one particular embodiment, the antenna 226 is configured for communication according to the IEEE 802.11 protocol at frequencies such as 2.4 GHz and 3.7 GHz and 5 GHz. Also, the antenna 226 may include multiple structures for communication of other signals such as GSM signals.

The timing circuit 234 maintains timing and synchronization information for the client device 204. In one example, the client device receives timing or synchronization information periodically from the access point 202. This information may come in the form of a beacon signal transmitted by the access point 202. A Timing Synchronization Function (TSF) is specified in the IEEE 802.11 standard to ensure timing synchronization among radio devices in a network. A Timing Synchronization Function (TSF) keeps timers for all stations in the same network synchronized. All stations including the client device 204 maintain a local TSF timer. In one example, the TSF is based on a 1-MHz clock with 1 microsecond increments.

Timing synchronization is achieved by stations periodically exchanging timing information through beacon frames. Each station adopts a received timing if it is later than the station's own TSF timer.

In operation, the access point 202 and client device 204 are in selective wireless data communication. The access point 202 operates as a base station and provides data communication in a service area adjacent to the access point 202 to client devices or stations such as the client device 204. Data communication is conducted according to a protocol such as IEEE 802.11. The access point 202 operates as a host or server to client devices in the service area and establishes a communication network for the stations in the service area.

The client device 204 seeks entry to the network established by the access point 202. Network insertion occurs when the client device 204 is powered up in the service area or first acquires signals from the access point 202. Network insertion involves acquisition of timing information by the client device 204 from the access point 202. Timing information may be conveyed by one or more beacon signals or beacons communicated by the access point 202. The beacon or beacons have a format and timing defined by the controlling network protocol such as 802.11. A beacon may include identification information for the access point 202 and timing and synchronization information. Reliable communication between the access point 202 and the client device 204 requires synchronization of timing between the access point 202 and the client device 204. The client device 204 may only communicate during permitted times, as defined but the network protocol. This is required to ensure that the client device 204 does not transmit at the same time as the access point 202 or at the same time as other client devices. One or more radios in the network transmitting on the same frequency or channel at the same time will prevent reliable communication due to clashing at the intended receiver.

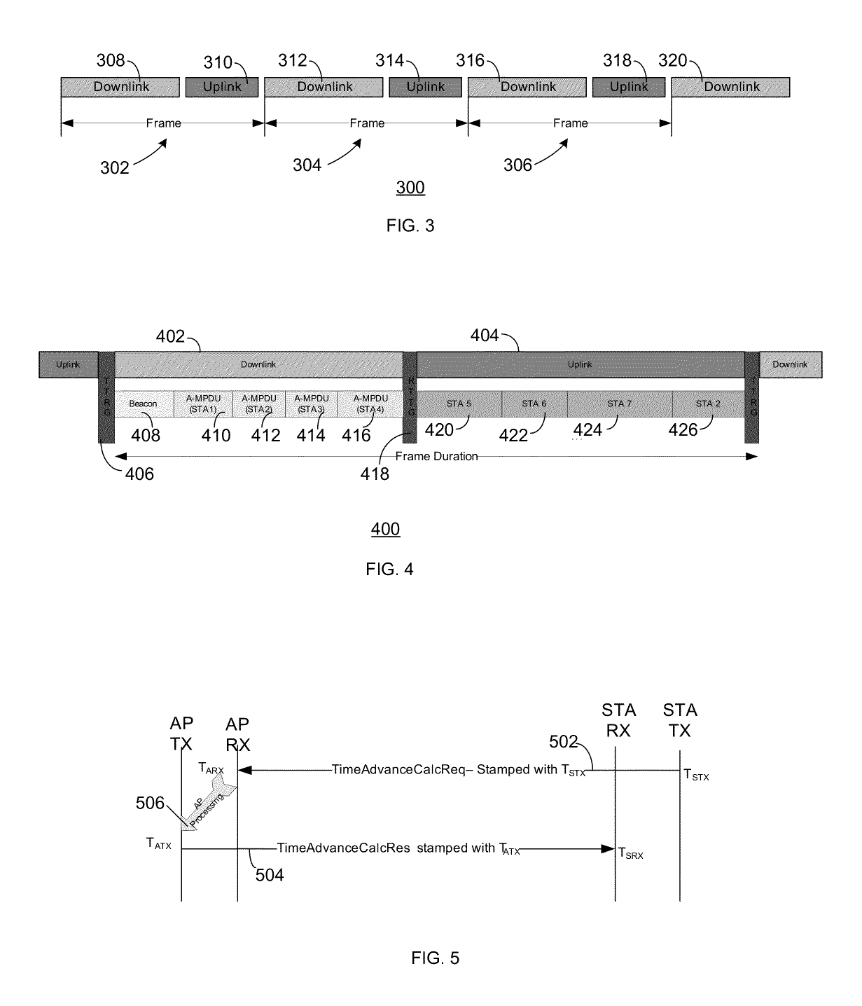

FIG. 3 is a timing diagram illustrating operation of the communication system 100 of FIG. 1. FIG. 3 illustrates a sequence 300 of time division duplex (TDD) frames for wireless communication in a communication system using a network protocol such as 802.11. In particular, the sequence 300 of frames has application in extended range networks such as 802.11 networks having a service area diameter greater than a few tens of meters.

The sequence 300 of frames includes a first frame 302, a second frame 304 and a third frame 306. In FIG. 3, time is on the horizontal access. The first frame 302 includes a downlink 308 followed in time by an uplink 310. Similarly, the second frame 304 includes a downlink 312 followed in time by an uplink 314 and the third frame 306 includes a downlink 316 followed in time by an uplink 318. A subsequent downlink 320 indicated a following frame. Each respective downlink frame 308, 312, 316, 320 defines a time period when an access point such as the access point 108 (FIG. 1) transmits to stations or client devices in the service are of the access point. Each respective uplink frame 310, 314, 318 defines a time period when stations or client devices in the service area transmits to the access point. The composition and timing of each downlink or uplink is defined by the network protocol.

In order to scale up in size, a communication network such as the network formed by the access point 108 of FIG. 1 must synchronize its timing with other networks of the same technology or other technologies operating in the same frequency ranges. To synchronizing neighboring access points such as access points 102, 104, 106, 108, the network must operate in a time division duplex mode in which all neighbor access points transmit at the same time for a fixed duration, then switch to a receive mode for a fixed duration. This is done according to the sequence 300 of TDD frames of FIG. 3. During the downlink frames 308, 312, 316, 320, all access points 102, 104, 106, 108 transmit in synchrony. During the uplink frames, all access points 102, 104, 106, 108 receive in synchrony.

FIG. 4 is a timing diagram illustrating operation of the communication system of FIG. 1. In particular, FIG. 4 illustrates an example of a TDD frame 400. The exemplary TDD from 400 may be used in a communication system such as the communication system of FIG. 1. For example, the exemplary TDD frame 400 may be used in a network protocol such as IEEE 802.11. The TDD frame 400 includes a downlink sub-frame 402 and an uplink sub-frame 404.

The uplink sub-frame 402 is separated from the immediately preceding uplink by a transmit receive guard 406. The transmit receive guard 406 accommodates variations in timing among stations that might be transmitting on the preceding uplink sub-frame and the access point transmitting on the downlink sub-frame 402.

In the illustrated example, the downlink sub-frame 402 includes a beacon 408, a first MAC protocol data unit (MPDU) 410, a second MPDU 412, a third MPDU 414 and a fourth MPDU 416. The beacon 408 is transmitted by the access point as a broadcast for all stations or client devices in the service area served by the access point. The beacon 408 includes identification and timing information. The beacon 408 may be used by receiving stations for synchronizing their local timing to network timing established by the access point. As discussed above in connection with FIG. 2, the access point establishes and maintains network timing. This is done, for example, by receipt and processing of GPS signals to determine with high precision current time. Information about the current time is encoded as time data and communicated in the beacon 408.

The respective MPDUs 410, 412, 414, 416 are communicated on the downlink sub-frame 402 by the access point to respective stations. Thus, as indicated in FIG. 4, the first MPDU 410 is communicated for reception by the client device designated STA 1. Similarly, the second MPDU 412 is communicated for reception by the client device designated STA 2; the third MPDU 414 is communicated for reception by the client device designated STA 3 and the fourth MPDU 416 is communicated for reception by the client device designated STA 4. As shown in the example of FIG. 4, the MPDUs 410, 412, 414, 416 are aggregated MPDUs, or A-MPDUs, as specified for 802.11n networks to increase data throughput in the network. The downlink sub-frame 402 is separated from the uplink sub-frame 404 by a receive transition gap 418.

The uplink sub-frame 404 includes respective time slots for transmission by respective stations or client devices. In the illustrated example, the uplink sub-frame 404 includes a time slot 420 designated for transmission by a station identified as STA 5, a time slot 422 designated for transmission by a station identified as STA 6, a time slot 424 designated for transmission by a station identified as STA 7 and a time slot 426 designated for transmission by a station identified as STA 2. Timing and assignment of the time slots 420, 422, 424, 426 is controlled by the access point and communicated in the beacon 408.

Multiple stations can transmit in the uplink sub-frame 404 as shown in FIG. 4. For successful reception at the access point, the stations' transmissions must not overlap regardless of the stations' distance from the access point. Each respective transmission by each respective station must be received at the access point at the exact time as determined the access point in the UL sub-frame 404.

However, as noted above in connection with FIG. 1, respective stations may be distant from the access point. Particularly in a network or service area having a large cell size, the distance may be significant. The distance may be so significant that the propagation delay between the station and the access point may be sufficient to affect synchronization of transmissions by the stations in the service area of the access point. A distant station may transmit at the time dictated by its local clock, synchronized to the access point timing, but because of the propagation delay to the access point, the transmitted signal is delayed and arrives in the following time slot, clashing with the transmission of another station which is assigned to that time slot. This will reduce reliability of communication in the network. Moreover, because some of the stations may be mobile and moving around the service area, the propagation delays may be changing over time.

For the proposed TDD solution to work, some respective stations need to transmit earlier than the allocated time to compensate for the propagation delay so that transmissions arrive at the access point at the exact time. Stations require a mechanism to advance their transmission time to compensate for the propagation delay.

However, the IEEE 802.11 standard does not provide a mechanism for nodes to advance their transmission time because the 802.11 network was not designed to be deployed in a synchronized TDD network. Therefore, a new mechanism is needed for stations to advance their transmission time in order to avoid transmission collisions. A mechanism for the station to calculate the timing advance is described below in conjunction with FIG. 5.

FIG. 5 is a flow diagram illustrating communication between an access point and a station (STA) or client device in a communication system such as the communication system of FIG. 1. FIG. 5 illustrates messages communicated between a station, on the right of FIG. 5, and an access point, on the left of FIG. 5.

The exemplary method may be performed at network insertion by the station. Network insertion occurs when the station first enters the network controlled by the access point and begins communicating with the access point. Thus, network insertion may occur when the station is powered up in the service area and begins communication. Or, network insertion may occur when the station is mobile and moves into the service area. At network insertion, the station first receives information from the access point about system timing, identification and capabilities. This information may be received, for example, in a beacon such as the beacon 408 (FIG. 4) transmitted by the access point on the downlink for broadcast reception by all stations in the service area. In one embodiment, the following procedure may be performed to adjust transmission timing of the station prior to communicating any data from the station to the access point.

Two new messages are defined for communication between the station and the access point. A first message, TimeAdvanceCalcReq, is a timing advance calculation request message transmitted by the station to the access point to request information necessary for calculating the timing advance to be used by the station during subsequent transmissions. A second message, TimeAdvanceCalcRes, is a timing advance calculation response message transmitted by the access point to the station in response to the timing advance calculation request message received from the station. The timing advance calculation response message includes the information necessary for calculating the timing advance. The procedure is triggered by the STA planning to associate with the AP.

At step 502, the station formats the TimeAdvanceCalcReq message. In one embodiment, this message is a MAC frame. Further in this embodiment, the station transmits the message in a contention window. The contention window is a time period on the uplink sub-frame when stations with information to transmit may do so if no other station is transmitting. If another station is transmitting, the station waits a time interval before re-trying the transmission. Accordingly, at step 502, the station attempts to transmit the TimeAdvanceCalcReq message in accordance with contention window procedures.

In accordance with one embodiment, the station time stamps the TimeAdvanceCalcReq message with the time of transmission of the message. This time may be obtained as the station's timing synchronization function (TSF) time when the transmission leaves the radio of the station. This time of transmission by the station of the timing advance calculation request message may be labeled T_{STX}. The time stamp may be achieved in any suitable manner. In one embodiment, the time stamp is included in a data field of the TimeAdvanceCalcReq message. The station's initial transmission is in a contention window that is offered by the access point periodically with a predefined duration larger than the time needed to transmit the TimeAdvanceCalcReq frame using the lowest modulation and coding scheme.

The access point receives the timing advance calculation request message from the transmitting station. Upon reception, the access point time stamps the TimeAdvanceCalcReq message with its TSF time. The time or reception by the access point of the timing advance calculation request message may be labelled T_{ARX}.

At step 506, the access point processes the timing advance calculation request message. Processing may include decoding the message, queuing the message for handling, and queuing a response for transmission to the station. In some instances, the processing time may be significant and non-zero. For maximum accuracy in determining a timing advance value for subsequent use by the station, the processing time required by the access point is evaluated and accounted for in determination of the timing advance value.

At step 504, access point transmits a timing advance calculation response message. This message may be transmitted in a TimeAdvanceCalcRes frame. The access point time stamps the response with its TSF time at the time of transmission of the timing advance calculation response message. The time when the access point transmits the response message may be labelled T_{ATX}. The access point includes in the TimeAdvanceCalcRes frame the time T_{ARX} when the access point received the TimeAdvanceCalcReq message from the station as well as the transmit time of the TimeAdvanceCalcReq message, labelled T_{STX}. Thus, the timing advance calculation response message transmitted by the access point includes data defining three times: the time of transmission of the timing advance calculation request message by the station, T_{STX}, the time of receipt at the access point of the timing advance calculation request message, labelled T_{ARX}; and the time of transmission of the timing advance calculation response message, labelled T_{ATX}. Data defining these time values may be encoded and transmitted in the TimeAdvanceCalcReq in any suitable manner, in any suitable data field for example.

Further in step 504, the timing advance calculation response message is received at the station which initially transmitted the timing advance calculation request message. When the TimeAdvanceCalcRes message is received by the station, the station records the time of reception of the message. This time may be labelled T_{SRX}. Thus, upon receipt of the TimeAdvanceCalcRes message at the station, the station has the following timings that can be used to calculate the timing advance value: (T_{SRX}), (T_{SRX}), (T_{ATX}) and (T_{ARX}).

The total turnaround time (T_{TAT}) of the timing advance calculation procedure at station is given by

T_{TAT}=T_{SRX}−T_{STX}

T_{TAT} in turn is equal to the time required to transmit the TimeAdvanceCalcReq frame from the station to the access point and the time required to transmit the TimeAdvanceCalcRes frame from the access point to the station, plus the processing and queuing time at the access point. The processing and queuing time is given by (T_{ARX}−T_{ARX}). Consequently, the following results:

T_{SRX}−T_{STX}=2*T_{PROP}+T_{ATX}T_{ARX}

Accordingly, the propagation delay (T_{PROP}) is given by

T_{PROP}=1/2(T_{SRX}−T_{STX}−T_{ATX}+T_{ARX})

Subsequently, the station uses the propagation delay T_{PROP} to advance its transmissions in order to be received by the AP at the scheduled time. For example, the station may synchronize its timing to access point timing, for example using a beacon to establish the local TSF function. The station may then use the synchronized timing to determine a nominal respective transmission time. The nominal respective transmission time is the time scheduled for a transmission by the station, for example, an assigned time slot. The station adjusts the nominal respective transmission time by the timing advance value to determine a respective transmission time. The respective transmission time is then used as the time to transmit a frame by the station to the access point to ensure that the frame is received at the access point without a collision.

The illustrated technique for determining propagation delay provides many unique advantages over conventional techniques. One advantage is to allow TDD synchronized wireless broadband networks based on 802.11n technology to synchronize frame timing with other networks and other radio technologies while minimizing overhead. Without implementation of the illustrated technique, a station would be required to provide additional buffer time in each uplink transmission to allow for the variation of station distances from the access point. This additional buffer time would represent additional overhead and reduced network efficiency. In contrast, by using the illustrated technique, substantial advantages of efficiency and reduced as overhead are realized.

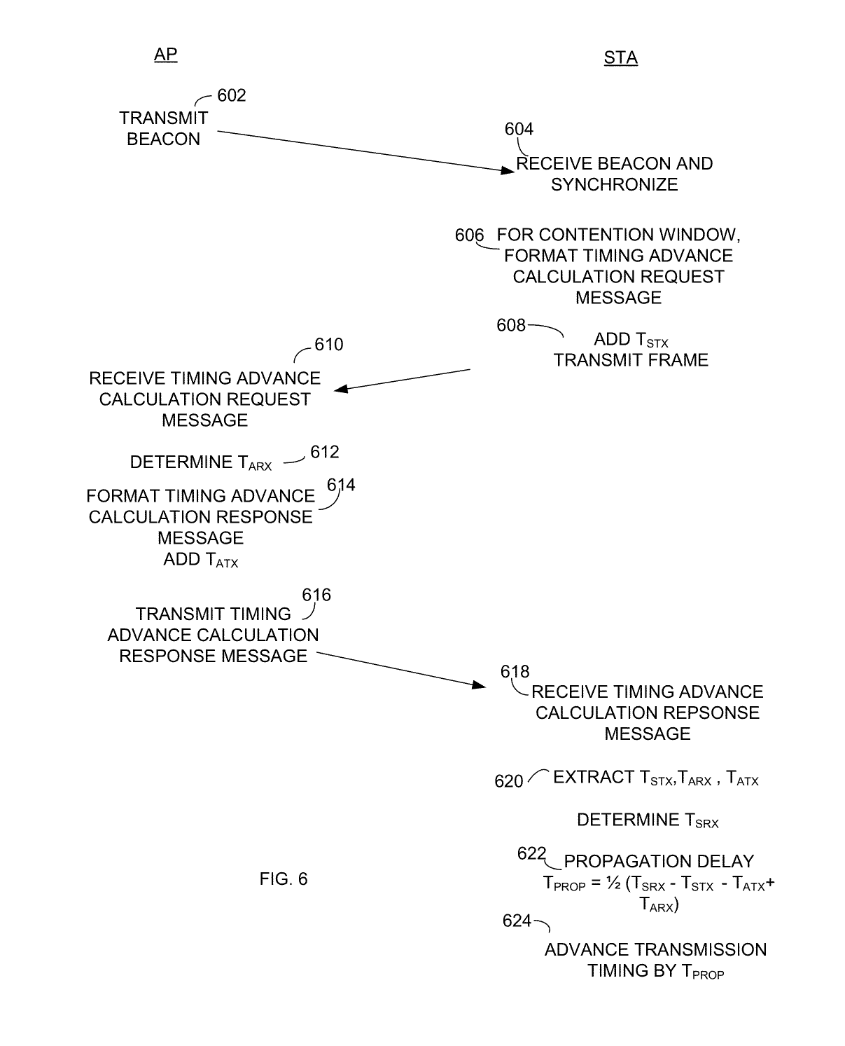

FIG. 6 is a flow diagram illustrating a method for determining timing advance in a communication network such as the communication network 100 of FIG. 1. The method may be performed, for example, at the time of network insertion when a station (STA) joins the communication network formed by an access point (AP). An exemplary network is one operating in accordance with IEEE standard 802.11n, conventionally known as WiFi. At network insertion, the STA is powered up or enters the geographic area defining the service area where the AP communicates with stations.

The AP controls timing and communication in the service area. One feature of timing control is broadcast transmission of a beacon. At step 602, the AP transmits a beacon. The beacon is transmitted with timing and content defined by standard or protocol such as IEEE 802.11n. The beacon is intended for reception by any AP in the service area.

At step 604, the STA receives the beacon. The STA further synchronizes its local timing to the beacon. Further network timing, such as the timing for TDD frames, uplink sub-frames, downlink sub-frames and time slots is defined from the timing of the beacon. The STA establishes its local timing from the beacon for timing subsequent operations.

At step 606, the STA formats a timing advance calculation request message. Any suitable format may be used but the format should conform to the existing definitions of the controlling communication protocol such as 802.11n. At block 608, the STA determines the local time, adds data defining the local time to the timing advance calculation request message and transmits a frame with the message. The STA transmission time included in the message may be designated as T_{SRX}. In one embodiment, the message is transmitted during a contention window when no other STA in the network is transmitting.

At step 610, the AP receives the timing advance calculation request message. The AP extracts the STA transmission time T_{STX} from the message and at step 612 also records the time at which the AP received the message. This time may be designated T_{ARX}.

At step 614, the AP formats a timing advance calculation response message. The AP responds to the receipt by the AP of the timing advance calculation request message by recording the time of receipt of the message T_{ARX}, formatting the response message and including the transmission time of the response message. This time may be designated T_{ARX}. The timing advance calculation response message is formatted to include T_{STX}, T_{ARX} and T_{ARX}. At step 616, again in response to the timing advance calculation request message, the AP transmits the timing advance calculation response message to the STA.

At step 618, the STA receives the timing advance calculation response message and at step 620, the STA extracts from the response message the values of T_{STX}, T_{ARX} and T_{ATX}. The STA further determines the receipt time of the response message which may be designated T_{ARX}.

At block 622, the STA determines the propagation delay from the STA to the AP. The propagation delay may be determined as one-half the difference between the time of transmission of the timing advance calculation request message, or T_{STX}, and the time of receipt of the timing advance calculation response message, T_{SRX}. If higher accuracy is required, or if it is determined that the processing time and queuing time at the AP are not insignificant, the STA may also subtract out the time required for processing and queuing at the AP. This is equal to the difference between the time of receipt of the timing advance calculation request message at the AP, or T_{ARX}, and the time of transmission of the timing advance calculation response from the AP, or T_{ATX}. In this embodiment, then, T_{PROP}=1/2(T_{SRX}−T_{STX}−T_{ATX}+T_{ARX})

At step 624, for subsequent transmissions, the STA advances timing of all transmissions to the AP by an amount equal to the propagation delay T_{PROP}. This timing advance adjustment thus ensures that transmissions by the STA are received at the AP at the precise time required by the AP according to the network protocol or 802.11n. Further, this ensures that transmission collisions between the STA and other stations in the network are reduced or avoided. The effect on network timing of the propagation delay from the STA to the AP is compensated. This improves overall system reliability and efficiency as fewer collisions occur at the receiver of the AP.

In an alternative embodiment, the STA may update its propagation delay calculation. For example, if the STA is a mobile device such as a mobile phone or portable computer, the STA may move to a different location in the service area. The movement may significantly affect the propagation delay from the STA to the AP. In such an instance, the timing advance calculation process illustrated in FIG. 6 may be repeated to update the propagation delay calculation. The new or updated propagation delay can subsequently be used to advance timing of STA transmissions.

The propagation delay calculation may be updated according to any convenient procedure. In one example, the propagation delay calculation may be updated at each network insertion. In another example, the propagation delay calculation may be updated periodically, such as hourly or daily. In another example, the propagation delay calculation may be updated dynamically, such as when the STA determines an increasing number of transmissions are missed, indicating the current propagation delay may be out of date, such as when the STA has moved to a new location with a substantially different propagation delay.

The frequency of updating of the propagation delay calculation may require balancing of the improvement in network performance and reliability afforded by accurate calculation of the propagation delay and compensation therefor, on the one hand, and the added network overhead required for the propagation delay calculation on the other hand. The propagation delay calculation procedure as illustrated in FIG. 6 requires communication of two messages in the network. In a busy network, this overhead may be unacceptable unless error rate due to propagation delay becomes excessive.

From the foregoing, it can be seen that the presently disclosed embodiments provide an improved system and method for reliable wireless communication. Two new messages are developed to permit a propagation delay calculation for a WiFi station. The WiFi station transmits a timing advance calculation response message with its transmission time included in the message. A receiving base station or access point responds to the message by replying with a timing advance calculation response message. The access point formats the response message to include the transmission time for the request message, received from the station, as well as the receipt time of the request message at the access point and the transmission time of the response message from the access point. The station receives the timing advance calculation response message and determines propagation delay from the station to the access point. The station subsequently advances timing of its transmissions to the access point by an amount equal to the determined propagation delay. In this manner the timing of transmission compensates for the propagation delay to provide a correct timing of receipt at the access point.

It is therefore intended that the foregoing detailed description be regarded as illustrative rather than limiting, and that it be understood that it is the following claims, including all equivalents, that are intended to define the spirit and scope of this invention.

1. A method comprising:
at a wireless client device,
formatting a first message to request timing information, the first message including a request transmission time T_{STX};
transmitting the first message to a serving access point,
receiving a response message from the serving access point, the response message including the transmission time T_{STX};
determining a response receipt time T_{SRX} when the response message was received;
determining a timing advance value using the difference between the request transmission time T_{STX} and the response receipt time T_{SRX};
subsequently, determining transmission times for communicating with the serving access point; and
transmitting respective messages to the serving access point at a time preceding respective transmission times by the timing advance value to compensate for propagation delay in between the wireless client device and the serving access point.

2. The method of claim 1 further comprising:
at a wireless client device, receiving a beacon transmission from the serving access point;
synchronizing timing of the wireless client device to timing of the received beacon; and
determining the transmission times using the synchronized timing of the wireless client device.

3. The method of claim 1 wherein receiving the response message comprises:
determining in the response message a request receipt time T_{ARX};
determining in the response message a response transmission time T_{ATX};
and wherein determining the timing advance comprises:
determining a propagation delay T_{PROP} according to
T_{PROP}=1/2(T_{SRX}−T_{STX}−T_{ATX}+T_{ARX}).

4. The method of claim 3 wherein transmitting respective messages comprises:
determining a respective transmission time for a respective message;
advancing the respective transmission time by the propagation delay; and
transmitting the respective message from the wireless client device to the serving access point at the advanced respective transmission time.

5. The method of claim 3 wherein transmitting respective messages comprises transmitting messages according to Institute of Electrical and Electronic Engineers Standard (IEEE) 802.11 or a version thereof.

6. The method of claim 5 wherein transmitting respective messages comprises transmitting messages according to IEEE 802.11n between a station (STA) acting as the wireless client device and an access point (AP) acting as the serving access point.

7. The method of claim 6 wherein receiving a response message from the serving access point comprises receiving a response from an 802.11n AP operating in a time division duplex mode in which the 802.11n AP and all neighbor access points transmit at the same time for a fixed duration, then switch to a receive mode for a fixed duration.

8. A method comprising:
synchronizing timing of an 802.11 wireless client device with an access point;
determining a timing advance value for transmissions from the 802.11 wireless client device to the access point;
subsequently, determining respective transmission times for respective transmissions from the 802.11 wireless client device using the synchronized timing of the 802.11 wireless client device to determine a nominal respective transmission time and adjusting the nominal respective transmission time by the timing advance value to determine a respective transmission time; and
transmitting messages from the 802.11 wireless client device to the access point at the respective transmission times.

9. The method of claim 8 wherein determining the timing advance value comprises:
transmitting a timing advance request message from the wireless client device for reception by the access point, the timing advance request message including transmission timestamp data indicating time of transmission at the wireless client device of the timing advance request message;
receiving at the wireless client device a timing advance response message transmitted by the access point, the timing advance response message including the transmission timestamp data included in the timing advance request message;
determining reception timestamp data indicating time of reception of the timing advance response message at the wireless client device;
determining access point processing time data from the timing advance response message;
determining a timing advance value as a difference between the reception timestamp data, the transmission timestamp data and the access point processing data;
subsequently, advancing transmission timing for transmissions to the serving access point by the timing advance value.

10. The method of claim 9 wherein determining access point processing time data from the timing advance response message comprises:
receiving request message receipt time data from the timing advance response message;
receiving response message transmission time data from the timing advance response message; and
determining the access point processing time data as a difference between the request message receipt time data and the response message transmission time data.

11. The method of claim 8 further comprising:
subsequently, determining an updated timing advance value for transmissions from the 802.11 wireless client device to the access point; and
thereafter, adjusting the nominal respective transmission times by the updated timing advance value to determine respective transmission times.

12. A method comprising:
at an 802.11 access point, receiving a timing advance request message transmitted by a wireless client;
determining a request message receipt time for the reception of the timing advance request message at the access point;
extracting request message transmission time data from the timing advance request message transmitted by the wireless client;
formatting a response message with the request message transmission time data, request message receipt time data corresponding to the determined request message receipt time and response message transmission time data corresponding to a transmission time for the response message; and
transmitting the response message for reception by the wireless client.

13. The method of claim 12 further comprising:
subsequently, receiving synchronized transmissions from the wireless client.

14. The method of claim 12 further comprising:
at the 802.11 access point, operating in a time division duplex mode in which the 802.11 access point and all neighbor access points transmit at the same time for a fixed duration, then switch to a receive mode for a fixed duration.

15. A wireless device comprising:
a radio circuit for radio communication with a remote access point;
a host processor operative to control the wireless device for communication with the remote access point, including transmit a request message to the remote access point,
receive a response message from the remote access point,
determine propagation delay for radio communication between the wireless device and the remote access point; and
for subsequent transmissions to the remote access point, advance timing of the subsequent transmissions using the propagation delay to compensate for the propagation delay.

16. The wireless device of claim 15 wherein the host processor is further operative to
determine a transmission time for the request message;
format the request message to include data defining the transmission time for the request message.

17. The wireless device of claim 16 wherein the host processor is further operative to
extract from the response message the data defining the transmission time for the request message;
determine a receipt time of the response message at the wireless device, and
determine the propagation delay based on the difference between the transmission time for the request message and the receipt time of the response message.

18. The wireless device of claim 17 wherein the host processor is further operative to
extract from the response message data defining receipt time of the request message at the remote access point;
extract from the response message data defining transmission time of the response message by the remote access point; and
determine a processing delay at the remote access point as a difference between the data defining receipt time of the request message and the data defining transmission time of the response message.

19. The wireless device of claim 16 wherein the host processor is further operative to
extract from the response message the data defining the transmission time for the request message;
extract from the response message data defining receipt time of the request message at the remote access point;
extract from the response message data defining transmission time of the response message by the remote access point;
determine a receipt time of the response message at the wireless device, and
determine the propagation delay using the data defining the transmission time for the request message, the data defining receipt time of the request message, the data defining transmission time of the response message and data defining the receipt time of the response message.

20. The wireless device of claim 15 further comprising:
a timing circuit configured to maintain timing information for the client device,
wherein the host processor is operative to determine timing of subsequent transmissions from timing information of the timing circuit.
